(19) United States
(12) Patent Application Publication
(10) Pub. No.: US 2025/0299292 A1
(43) Pub. Date: Sep. 25, 2025

(54) MULTIRANGE SINGLE CAMERA FOR VEHICLE VISION SYSTEMS

(71) Applicant: GM Global Technology Operations LLC, Detroit, MI (US)

(72) Inventors: Sai Vishnu Aluru, Commerce Twp., MI (US); Chao-Hung Lin, Canton, MI (US)

(21) Appl. No.: 18/609,510

(22) Filed: Mar. 19, 2024

(51) Int. Cl. G06T 3/4038; G06T 3/4092; G06T 7/11; G06V 20/56

(52) U.S. Cl. CPC G06T 3/4038; G06T 3/4092; G06T 7/11; G06V 20/56

(57) ABSTRACT

An imaging system includes a multirange camera having an imager and a lens. The lens includes multiple zones and each zone is physically distinct from each other zone. A controller is in communication with the multirange camera. The controller includes a processor and a memory. The memory stores instructions configured to cause the processor to process an image received from the imager by separating the image into multiple distinct zone images, processing each distinct zone image using a processing procedure corresponding to a zone of the zone image being processed, recombining the zone images into a single processed image, and providing the single processed image to at least one vision system.

### INTRODUCTION

The subject disclosure relates to vehicle vision systems, and more particularly to a configuration for capturing multirange images using a single physical imager, such as a camera.

Modern vehicles utilize imaging to monitor and responded to a surrounding environment. Vehicle systems using imaging in this way can include driver assistance systems, such as back up cameras, semi-autonomous driving systems, such as parallel parking assistance systems, and fully automated driving systems. Systems that use imaging to aid in vehicle operations are referred to generally as vehicle vision systems.

In order to facilitate these systems multiple cameras are incorporated throughout the vehicle. The cameras include different physical configurations and orientations allowing for the various vision ranges, and required fields of view, of each system requiring imaging to be accommodated. Each required camera increases weight and complexity of the vehicle. As such, it is desirable to reduce the number of cameras required on the vehicle while still providing all of the views required to enable operation of the desired vehicle vision systems.

### SUMMARY

In one exemplary embodiment an imaging system includes a multirange camera having an imager and a lens. The lens includes multiple regions and each region is physically distinct from each other region. A field of view generated by the camera includes a plurality of zones. A controller is in communication with the multirange camera. The controller includes a processor and a memory. The memory stores instructions configured to cause the processor to process an image received from the imager by separating the image into multiple distinct zone images, separately processing each distinct zone image using a processing procedure corresponding to a zone of the zone image being processed, recombining the distinct zone images into a single processed image, and providing the single processed image to at least one vision system.

In addition to one or more of the features described herein each zone includes a lens distortion distinct from a lens distortion in each other zone.

In addition to one or more of the features described herein each zone includes a pixel density distinct from a pixel density of each other zone.

In addition to one or more of the features described herein each zone is a single continuous shape.

In addition to one or more of the features described herein at least one zone is a plurality of discontinuous shapes.

In addition to one or more of the features described herein separating the image into multiple distinct zone images includes providing the image and a set of X,Y blanking zones to a serializer/deserializer module of the controller and outputting a plurality of zone images from the serializer/deserializer module.

In addition to one or more of the features described herein a number of zone images in the plurality of zone images is equal to a number of zones in the plurality of zones.

In addition to one or more of the features described herein, the imaging system further includes sequentially ordering the multiple distinct zone images using a frame concatenation module.

In addition to one or more of the features described herein processing each distinct zone image using a processing procedure corresponding to the zone image being processed includes at least one of edge enhancement of the zone image and pixel density normalization of the each distinct zone image.

In addition to one or more of the features described herein processing each distinct zone image using a processing procedure corresponding to the zone image being processed includes each of edge enhancement of the zone image and pixel density normalization of the zone image.

In addition to one or more of the features described herein the at least one vision system is a vehicle vision system.

In another exemplary embodiment a method for providing images to a vision system includes receiving a base image from a multirange camera at a controller. The multirange camera has an imager and a lens, with the lens, having a plurality of zones. Each zone in the plurality of zones is physically distinct from each other zone. The method separates the base image into multiple distinct zone images, using the controller. The method processes each distinct zone image with the controller, using a processing procedure corresponding to the zone image being processed. The method recombines the zone images into a single processed image and provides the single processed image to at least one vision system.

In addition to one or more of the features described herein separating the base image into multiple zone images includes providing the base image and a set of X,Y blanking zones to a serializer/deserializer module of the controller and outputting a plurality of zone images from the serializer/deserializer module.

In addition to one or more of the features described herein a number of zone images in the plurality of zone images is equal to a number of zones in the plurality of zones.

In addition to one or more of the features described herein, the method further includes further comprising sequentially ordering the multiple distinct zone images using a frame concatenation module of the controller.

In addition to one or more of the features described herein processing each distinct zone image using a processing procedure corresponding to the zone image being processed includes at least one of edge enhancement of the zone image and pixel density normalization of the zone image.

In addition to one or more of the features described herein processing each distinct zone image using a processing procedure corresponding to the zone image being processed includes each of edge enhancement of the zone image and pixel density normalization of the zone image.

In addition to one or more of the features described herein the at least one vision system includes a vehicle vision system.

In addition to one or more of the features described herein each zone includes at least one of a lens distortion distinct from a lens distortion in each other zone and a pixel density distinct from a pixel density of each other zone.

In one exemplary embodiment a vehicle includes an imaging system having a multirange camera having an imager and a lens. The lens includes multiple regions and each region is physically distinct from each other region. A field of view generated by the camera includes a plurality of zones. A controller is in communication with the multirange camera. The controller includes a processor and a memory. The memory stores instructions configured to cause the processor to process an image received from the imager by separating the image into multiple distinct zone images, separately processing each distinct zone image using a processing procedure corresponding to a zone of the zone image being processed, recombining the distinct zone images into a single processed image, and providing the single processed image to at least one vision system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a top view of a motor vehicle including a multirange camera for use with vehicle vision systems;

FIG. 2 depicts a side view of a multirange camera, and a corresponding field of view;

FIG. 3 depicts X,Y blocking zones of an image received from the multirange camera of FIGS. 1 and 2;

FIG. 4 depicts an alternate example X,Y blocking zone configuration of the multirange camera of FIGS. 1 and 2;

FIG. 5 depicts a general method for processing images from a multirange camera for use in vehicle vision systems;

FIG. 6 depicts a specific exemplary method for integrating images from a given multirange camera into a vehicle vision system; and

FIG. 7 depicts a forward view of a camera lens.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein “vehicle vision systems” refers to any vehicle system utilizing or employing digitally generated images of an environment. Vehicle vision systems can include, but are not limited to, driver awareness systems, driver monitoring systems, assisted driving systems, and autonomous vehicle operation systems.

In accordance with an exemplary embodiment methods, devices and systems are provided for configuring and implementing a multirange camera based vision system within a vehicle. In one example, a single camera includes a lens configured with two or more distinct range zones (e.g., a close range zone, a mid range zone, and a far range zone). Each of the distinct range zones is configured to provide the most clear resolution of objects at the range in which the zone is designated. By way of example, the portion of the lens configured for a close range zone provides a most clear resolution of objects within the field of view that are in close range to the camera while the portion of the lens configured for a long range zone provides a most clear resolution of areas of the field of view including only long range objects.

In addition to one or more cameras including multirange lenses, one or more controllers within the vehicle include an image processing process configured to isolate each zone of the multirange camera, process the isolated zones with a corresponding image processing, combine the isolated zones into a resultant zoned image, and provide the resultant zoned images to corresponding vehicle vision systems for utilization.

Embodiments described herein present numerous advantages and technical effects, including a decrease in the number and size of cameras required to implement various vehicle vision systems. Alongside the decreased number and size of the cameras is a corresponding decrease in the weight and complexity of the overall vehicle incorporating the multirange cameras.

The embodiments are not limited to use with any specific vehicle and may be applicable to various other contexts in addition to vehicle systems. For example, multirange cameras and the corresponding processing may be used in automated agricultural equipment, stationary surveillance equipment (e.g., security cameras), or any similar application where multiple ranges within a single field of view are desired to be effectively utilized.

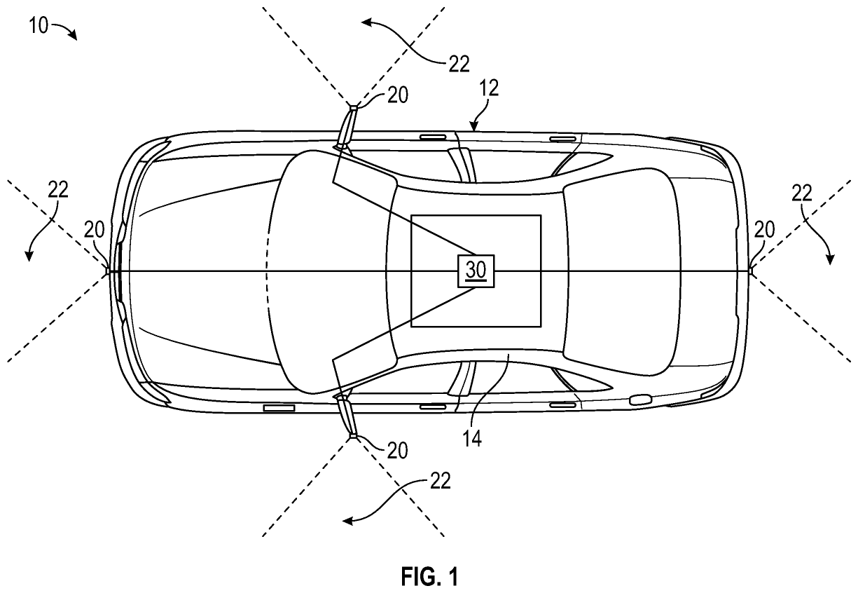

FIG. 1 shows an embodiment of a motor vehicle 10, which includes a vehicle body 12 defining, at least in part, an occupant compartment 14. The vehicle 10 may be an electrically powered vehicle (EV) or a hybrid vehicle. In an embodiment, the vehicle 10 is an electric vehicle including at least one electric motor assembly. The vehicle body 12 also supports various vehicle subsystems including a propulsion system, and other subsystems to support functions of the propulsion system and other vehicle components, such as a braking subsystem, a suspension system, a steering subsystem, and others.

In addition, the vehicle 10 includes multiple multirange cameras 20 (alternately referred to generically as “cameras”) disposed about the vehicle body 12. Each of the cameras 20 defines a corresponding field of view 22. The field of view 22 is the area that is visible to the camera 20. While illustrated as four externally facing cameras 20, it is appreciated that the vehicle 10 may include multiple additional external facing cameras, one or more internally facing cameras, or any other configuration of additional cameras as may be required by corresponding vehicle vision systems, and any or all of the cameras may benefit from being constructed as multirange cameras.

Each camera 20 is in communication with a corresponding vehicle controller 30. The communication may be via a direct digital link, a wireless link, a combination of direct digital and wireless, an analog link, indirect communication through a vehicle communication bus, or any other form of communication configured to provide a generated image from the camera 20 to the controller 30.

The controller 30 is, in one example, a dedicated vision systems controller configured to receive and analyze the image feeds from the cameras 20 and provide the necessary image processing to allow the images from the cameras 20 to be utilized by corresponding vehicle vision systems. In other examples, the controller 30 may be one or more control modules running within a general controller, multiple modules distributed across multiple controllers, or any other controller configuration.

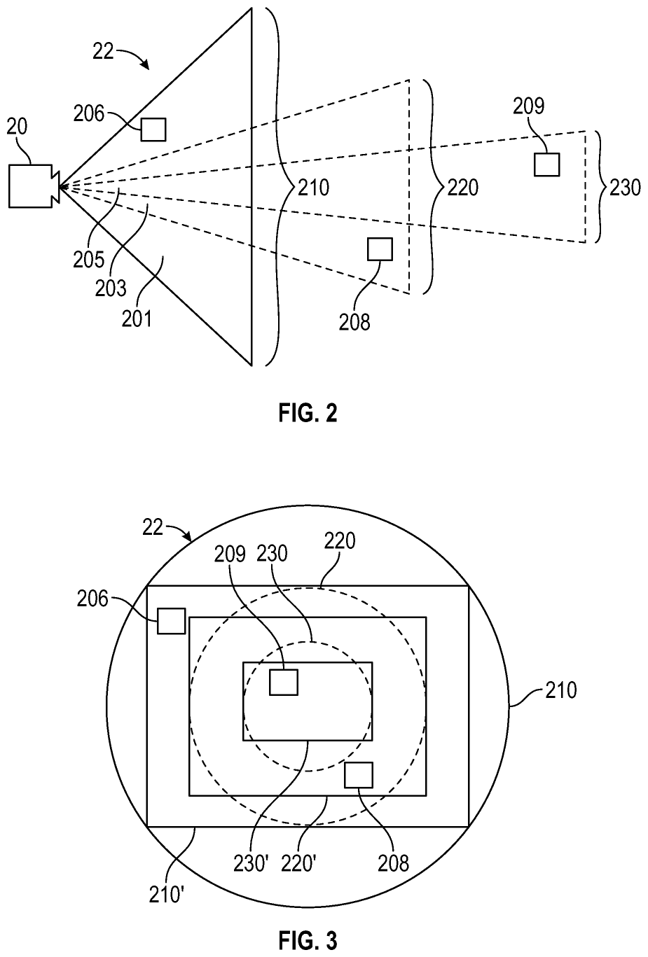

With continued reference to FIG. 1, FIG. 2 illustrates a side view of an example camera 20 defining a field of view 22, including three zones 210, 220, 230. Within the field of view 22 are multiple objects 206, 208, 209. The field of view 22 encompasses a short range area 201 defining a short range zone 210, a mid range area 203 defining a mid range zone 220 and a long range area 205 defining a long range zone 230, with some objects 206 being present in the short range area 201, some objects 208 being present in the mid range area 203 and some objects 209 being present in the long range area 205. As used herein, the range of an object refers to the object's real world distance from the camera 20 defining the field of view 22 including the object.

For the purposes of image processing, the field of view 22 as seen by the camera 20 is broken into the three zones 210, 220, 230. The short range zone 210 includes objects 206 that are close, objects 208 that are mid range, and objects 209 that are long range. The mid range zone 220 includes objects 208 that are mid range and objects 209 that are long range. The long range zone 230 includes only objects 209 that are long range.

FIG. 3 illustrates an example field of view 22, where the field of view 22 is divided into nested rectangular zones 210′, 220′, 230′, with rectangular zone 210′ corresponding to the short range zone 210, rectangular zone 220′ corresponding to the mid range zone 220, and rectangular zone 230′ corresponding to the long range zone 230. It is appreciated that the zones 210, 220, 230 can be arranged in any shape or configuration including any number of range zones as required by a given camera placement.

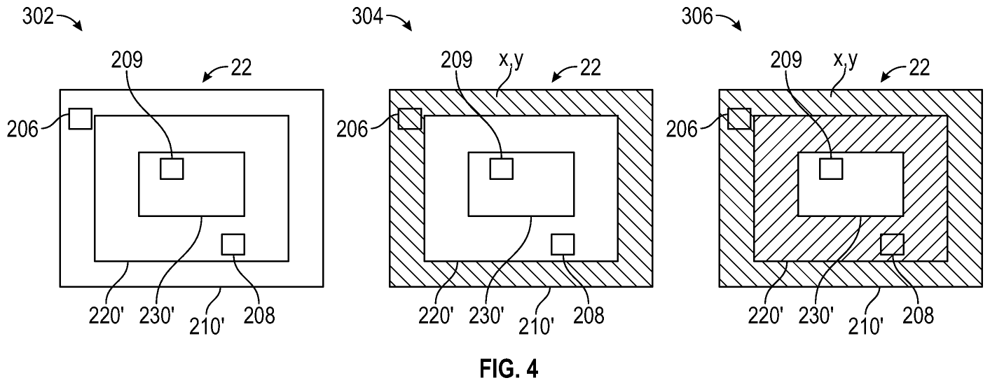

In another example conceptualization the zones 210, 220, 230 are illustrated in FIG. 4 as three distinct frames 302, 304, 306 of the same field of view 22. Portions of a given frame 302, 304, 306 that are ignored for analysis at a corresponding range are referred to as being X, Y blanking zones. The first frame 302 illustrates the close range zone 210′ with no portion of the frame 302 being an X, Y blanking zone. The second frame 304 illustrates the mid range zone 220′ with a remainder of the frame 304 blanked out as an X,Y blanking zone, and the third frame 306 illustrates the long range zone 230′ with a remainder of the frame 306 blanked out as an X, Y blanking zone.

With reference to FIGS. 1-4, it is appreciated that certain physical camera structures, such as lens distortion and pixel density, are suited to generating ideal images of objects 206, 208, 209 at certain distances. As such, a given lens distortion and a given pixel density across the entirety of a lens 21 is not ideal for a multirange camera. To accommodate this aspect, the lens 21 of the camera 20 is physically divided into zones 702, 704, 706 corresponding to the zones 210, 220, 230 of the field of view 22.

Each zone 702, 704, 706 of the lens 21 has a unique and distinct physical special distortion and a corresponding unique pixel density that corresponds to the range of objects 206, 208, 209 that are captured within that zone 702, 704, 706. This distinct structure allows for better image quality at longer distances and for greater accuracy while tracking and detecting objects (e.g., objects 206, 208, 209) in motion using vehicle vision systems. The image processing performed by the controller 30 further allows for the multirange camera to produce a single image (e.g., a single frame) from the multiple zones 210, 220, 230.

With continued reference to FIGS. 1-4, FIG. 5 illustrates a high level image signal processing (ISP) process 500 by which the controller 30 processes images received from the camera 20 for use with one or more vehicle vision systems. Initially, the camera 20 generates a zoned image using the zoned lens 21 and a conventional digital imager. The zoned image is provided to the controller 30 in an “Acquire Zone Images” step 502. In this step 502, the images provided from the camera 20 are separated by the zones 210, 220, 230 such that each frame 22 from the camera 20 generates three distinct images (in the case of an example camera including 3 zones 210, 220, 230).

Once received, the images are calibrated and normalized by the controller 30 using image processing in a “Calibrate and Normalize” step 504.

The calibrated and normalized images are provided to a frame composer module within the controller 30 in a “Frame Composer” step 506. The frame composer combines the calibrated and normalized images into corresponding single frames that are then output to one or more vision systems 510 by the controller 30 in a Perception/Viewing output step 508.

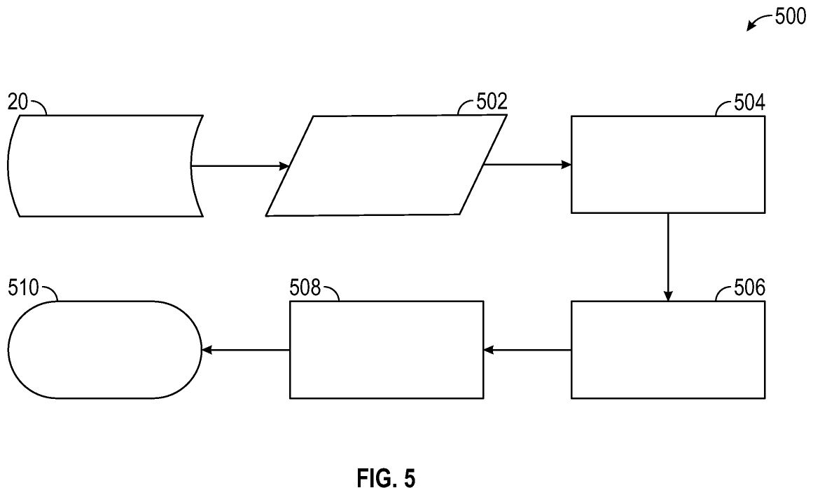

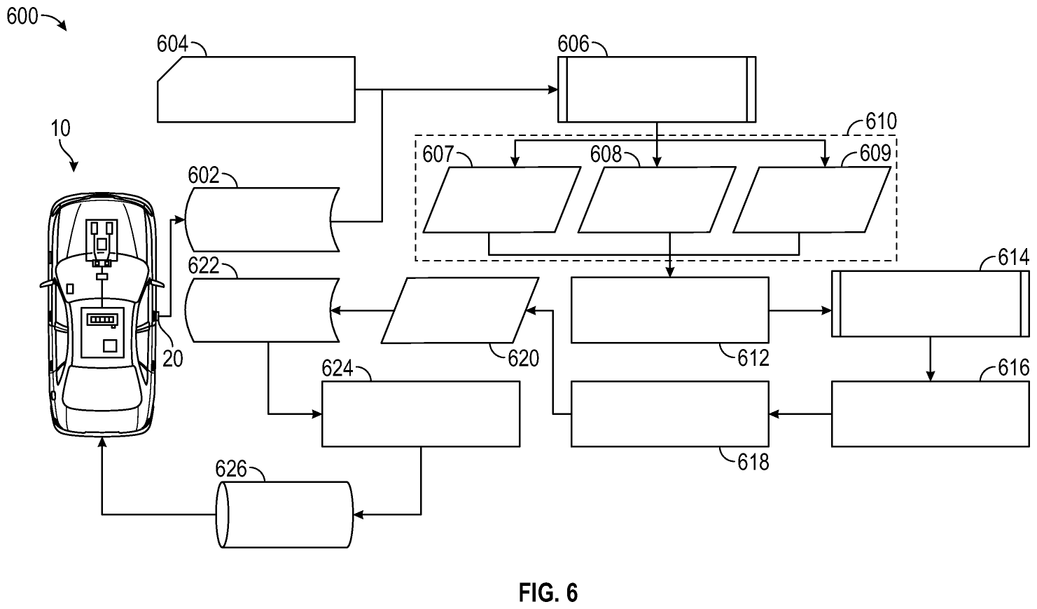

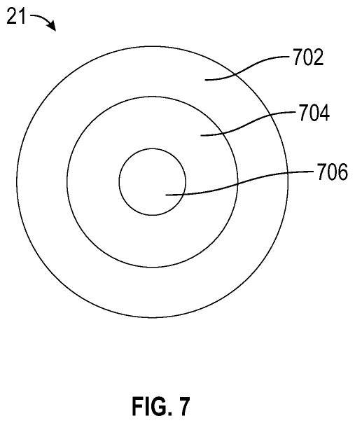

With continued reference to FIGS. 1-5, FIG. 6 illustrates one particular example process 600 for performing the general process 500 illustrated in FIG. 5. Initially, the camera 20 generates and outputs an image in a generate image step 602. The generated image includes the full field of view 22 as received through the zoned lens 21.

The image is provided to a serializer/deserializer (SerDes 606) along with an information set 604 defining the X,Y blanking zones of the image. The X,Y blanking zones define X,Y coordinates of each zone within the generated image based on the physical configuration of the zoned lens 21. The X,Y blanking zone data 604 can be stored in a local memory within the controller 30, stored elsewhere on the vehicle 10, contained within the camera 20 itself, or stored in any other accessible memory location.

The SerDes 606 splits each frame of the image into multiple zone images. In the example camera 20, which has a lens 21 defining three zones 210, 220, 230, the SerDes 606 splits the image into three zone images 607, 608, 609. Each of the zone images 607, 608, 609 is processed into a corresponding image array in a Process Zone Images step 610. The processing for each zone image is distinct, and corresponds to the classification of the zone 210, 220, 230 corresponding to that zone image 607, 608, 609. By way of example, if zone image 607 corresponds to the close range zone 210, the image processing of the zone image 607 during the process zone images step 610 is the close range image processing.

Once each zone image 607, 608, 609 has been processed, all the zone images 607, 608, 609 are provided to a frame concatenation processing block 612 where the zone images 607, 608, 609 are sequenced by the controller 30 for subsequent processing steps. The sequencing places the zone images 607, 608, 609 in a linear order allowing for sequential processing rather than parallel processing of the zone images 607, 608, 609.

Each zone image 607, 608, 609 is further processed in an edge enhancement step 614. During the edge enhancement step 614, the edges of each zone image 607, 608, 609 are manipulated using existing edge enhancement algorithms, and anti-aliasing is applied to the edges of the zone images 607, 608, 609. The edge enhancement assists with the zone based merging which occurs in a later Zone Based Merging step 618.

A pixel density of each zone image 607, 608, 609 is then normalized in a Normalize Pixel Density step 616. As the pixel density in each zone of the camera 20 is distinct, the resultant zone images 607, 608, 609 do not have a natively uniform pixel density. The normalization upscales and/or downscales the pixel density of one or more of the zones within the zone images 607, 608, 609 such that after normalization each zone image 607, 608, 609 includes the same pixel density.

After being normalized, the zone images corresponding to a single frame 22 are merged by the controller 30 in the Zone Based Merging step 618, and a single composed frame 620, corresponding to the initial frame 22 is generated. The single composed frame 620 has been fully processed into a single image frame to remove artifacts and variations that may arise as the result of the distinct zones 607, 608, 609 within the lens 21.

The composed frame 620 is provided to a standard image signal processing module 622, where the entire composed frame 620 is processed using an image signal processing system 624 within the vehicle controller 30 and then provided to a vehicle vision system 626. The vehicle vision system 626 then utilizes the composed frame 620 in any capacity including, but not limited to, object detection, collision avoidance, driver alerts, operation assistance and/or any other vehicle vision system.

While described throughout within the context of a multirange camera 20 having three zones 210, 220, 230, it is appreciated that any number of zones can be utilized depending on the particular vehicle vision systems that the image(s) are being provided to, and that the zones within a given field of view 22 are not limited to rectangular and/or nested zone shapes. In some practical embodiments, particular zones and shapes of zones can be determined via empirical testing and/or via computer modeling. Furthermore, as with the shapes and numbers of zones, the particular lines of delineation between the zones need not be evenly distributed, and the relative area of each zone is again dependent on the particular vehicle vision systems to which the resultant image(s) will be provided.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An imaging system comprising;
a multirange camera having an imager and a lens, wherein the lens includes a plurality of regions and wherein each region in the plurality of regions is physically distinct from each other region, and wherein a field of view generated by the camera includes a plurality of zones;
a controller in communication with the multirange camera, the controller including a processor and a memory, wherein the memory stores instructions configured to cause the processor to process an image received from the imager by separating the image into multiple distinct zone images, separately processing each distinct zone image using a processing procedure corresponding to the zone image being processed, recombining the zone images into a single processed image, and providing the single processed image to at least one vision system.

2. The imaging system of claim 1, wherein each zone includes a lens distortion distinct from a lens distortion in each other zone.

3. The imaging system of claim 1, wherein each zone includes a pixel density distinct from a pixel density of each other zone.

4. The imaging system of claim 1, wherein each zone is a single continuous shape.

5. The imaging system of claim 1, wherein at least one zone is a plurality of discontinuous shapes.

6. The imaging system of claim 1, wherein separating the image into multiple distinct zone images includes providing the image and a set of X,Y blanking zones to a serializer/deserializer module of the controller and outputting a plurality of zone images from the serializer/deserializer module.

7. The imaging system of claim 6, wherein a number of zone images in the plurality of zone images is equal to a number of zones in the plurality of zones.

8. The imaging system of claim 1, further comprising sequentially ordering the multiple distinct zone images using a frame concatenation module.

9. The imaging system of claim 1, wherein processing each distinct zone image using a processing procedure corresponding to the zone image being processed includes at least one of edge enhancement of each distinct zone image and pixel density normalization of each distinct zone image.

10. The imaging system of claim 9, wherein processing each distinct zone image using a processing procedure corresponding to the zone image being processed includes each of edge enhancement of the zone image and pixel density normalization of the zone image.

11. The imaging system of claim 1, wherein the at least one vision system is a vehicle vision system.

12. A method for providing images to a vision system comprising:
receiving a base image from a multirange camera at a controller, the multirange camera having an imager and a lens, wherein the lens includes a plurality of zones and wherein each zone in the plurality of zones is physically distinct from each other zone;
separating the base image into multiple distinct zone images, using the controller;
separately processing each distinct zone image with the controller, using a processing procedure corresponding to the zone image being processed;
recombining the zone images into a single processed image; and
providing the single processed image to at least one vision system.

13. The method of claim 12, wherein separating the base image into multiple zone images includes providing the base image and a set of X,Y blanking zones to a serializer/deserializer module of the controller and outputting a plurality of zone images from the serializer/deserializer module.

14. The method of claim 13, wherein a number of zone images in the plurality of zone images is equal to a number of zones in the plurality of zones.

15. The method of claim 12, further comprising sequentially ordering the multiple distinct zone images using a frame concatenation module of the controller.

16. The method of claim 12, wherein processing each distinct zone image using a processing procedure corresponding to the zone image being processed includes at least one of edge enhancement of the zone image and pixel density normalization of the zone image.

17. The method of claim 16, wherein processing each distinct zone image using a processing procedure corresponding to a zone of the zone image being processed includes each of edge enhancement of the zone image and pixel density normalization of the zone image.

18. The method of claim 12, wherein the at least one vision system includes a vehicle vision system.

19. The method of claim 12, wherein each zone includes at least one of a lens distortion distinct from a lens distortion in each other zone and a pixel density distinct from a pixel density of each other zone.

20. A vehicle comprising:
an imaging system including a multirange camera having an imager and a lens, wherein the lens includes a plurality of regions and wherein each region in the plurality of regions is physically distinct from each other region, and wherein a field of view generated by the camera includes a plurality of zones; and
a controller in communication with the multirange camera and configured to control one or more vehicle systems, the controller including a processor and a memory, wherein the memory stores instructions configured to cause the processor to process an image received from the imager by separating the image into multiple distinct zone images, separately processing each distinct zone image using a processing procedure corresponding to the zone image being processed, recombining the zone images into a single processed image, and providing the single processed image to at least one vision system.
